(19) United States
(12) Patent Application Publication
(10) Pub. No.: US 2007/0255786 A1
(43) Pub. Date: Nov. 1, 2007

(54) Method and system for managing meetings using group calling

(76) Inventors: Von A. Mock, Boynton Beach, FL (US); Jaime A. Borras, Miramar, FL (US); Joseph L. Dvorak, Boca Raton, FL (US); Eric T. Eaton, Lake Worth, FL (US); Juan C. Fernandez, Boca Raton, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/412,579

(22) Filed: Apr. 27, 2006

(51) Int. Cl. G06F 15/16

(52) U.S. Cl. 709/204

(57) ABSTRACT

The invention concerns a method (200) and system (100) for managing meetings using group calling. The method can include the steps of detecting (212) one or more meeting participants for a meeting, comparing (214) the detected meeting participants with a listing of scheduled meeting participants and generating (216) a dynamic group calling list that at least includes those scheduled meeting participants who have not been detected. As an example, the dynamic group calling list can be generated on a mobile communications device (122) of one of the detected meeting participants. The method can also include the step of simultaneously contacting (218) from the mobile communications device the scheduled meeting participants on the dynamic group calling list who have not been detected.

### BACKGROUND OF THE INVENTION

1. Field of the Invention

The present invention concerns the management of meetings and more particularly, the management of meetings through group calling on mobile communications devices.

2. Description of the Related Art

Human interaction remains a large part of the way that many companies do business. In particular, the employees of most companies typically meet in conference rooms to discuss various projects and other business-related material. As employees are saddled with more and more tasks, a greater number of meetings are being called. Because of work strains and the number of meetings involved, many employees are late arriving to such events, and valuable time is wasted waiting for the decision makers to show up. As such, it is desirable to have a system and method in place to enable employees to better manage all these business events that require their presence.

### SUMMARY OF THE INVENTION

The present invention concerns a method for managing meetings using group calling. The method can include the steps of detecting one or more meeting participants for a meeting, comparing the detected meeting participants with a listing of scheduled meeting participants and generating a dynamic group calling list that at least includes those scheduled meeting participants who have not been detected. As an example, the dynamic group calling list can be generated on a mobile communications device of one of the detected meeting participants. Moreover, the method can include the step of simultaneously contacting from the mobile communications device the scheduled meeting participants on the dynamic group calling list who have not been detected.

In one arrangement, the method can also include the step of signaling the scheduled meeting participants with an indication of the status of each of the scheduled meeting participants who have not been detected. For example, a scheduled meeting participant who cannot make the meeting may signal the other scheduled meeting participants that he/she cannot attend the meeting. As another example, the method can include the steps of tracking the location of a scheduled meeting participant who has not been detected, determining that the scheduled meeting participant who has not been detected and who is being tracked will likely attend the meeting based on the tracking process and signaling the other scheduled meeting participants with an indication that reflects this determination. Also, the scheduled meeting participant who has not been detected and who is being tracked can be signaled with a status request if it cannot be determined that the scheduled meeting participant will likely attend the meeting based on the tracking process.

In another arrangement, the method can include the steps of searching a directory for a predetermined rating of a detected meeting participant and signaling the scheduled meeting participants who have not been detected with an indication of the predetermined rating of the detected meeting participant. As an example, the predetermined rating can be an employee classification that can provide an indication as to the significance of the detected meeting participant to the meeting. In another arrangement, the detected meeting participants may be either physically detected at a meeting location or may be in communications contact with the detected meeting participants physically detected at the meeting location.

The present invention also concerns a system for managing meetings. The system can include a monitoring unit that can detect one or more participants for a meeting, an event database that can store information concerning the meeting, including at least a list of scheduled meeting participants and a meeting manager unit communicatively coupled to the monitoring unit and the event database. The monitoring unit can signal the meeting manager unit when it detects a meeting participant, and the meeting manager unit can compare the detected meeting participants with the list of scheduled meeting participants. In response, the monitoring unit can generate a dynamic group calling list that can at least include those scheduled meeting participants who have not been detected.

In one arrangement, the monitoring unit can detect meeting participants who are either physically at a meeting location or are in communications contact with the detected meeting participants physically at the meeting location. In addition, the monitoring unit may be a node permanently positioned inside a location for the meeting or may be a mobile communications device that can receive a signal from a location beacon positioned inside the location for the meeting.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for managing meetings in accordance with an embodiment of the inventive arrangements; and

FIG. 2 illustrates a method for managing meetings in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled” as used herein, are defined as connected, although not necessarily directly, and not necessarily mechanically.

The present invention concerns a method and system for managing meetings using group calling. In one arrangement, the method can include the steps of detecting one or more meeting participants for a meeting, comparing the detected meeting participants with a listing of scheduled meeting participants and generating a dynamic group calling list that at least includes those scheduled meeting participants who have not been detected. As an example, the dynamic group calling list can be generated on a mobile communications device of one of the detected meeting participants. In addition, the method can include the step of simultaneously contacting from the mobile communications device the scheduled meeting participants on the dynamic group calling list who have not been detected. As such, a person in attendance can easily and quickly contact those scheduled participants who have not yet arrived to evaluate the probability that such participants will participate.

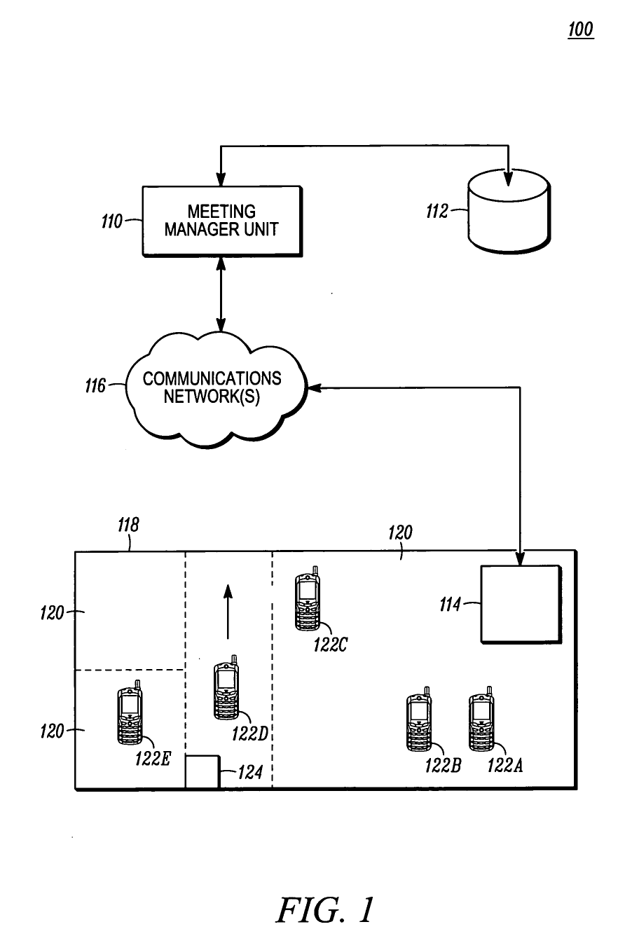

Referring to FIG. 1, an example of a system 100 for managing meetings is shown. In one arrangement, the system 100 can include a meeting manager unit 110, an event database 112 and one or more monitoring units 114. The meeting manager unit 110 can be communicatively coupled to the event database 112, and the event database 112 can be integrated into the unit 110, or it can be a completely separate component. Also, the event database 112 can be any suitable component or components that is or are suitable for storing various types of information, such as a list of scheduled meeting participants for any number of meetings. The meeting manager unit 110 can be any suitable combination of software and hardware for executing the processes that will be described below.

The monitoring unit 114 can be used to detect one or more meeting participants for a meeting. As an example, the monitoring unit 114 can be positioned inside a building 118, such as in a room 120, and can detect meeting participants as they enter the room 120. In one arrangement, the meeting manager unit 110 and the monitoring unit 114 can be communicatively coupled to one another through one or more communications networks 116. Although shown as a hard-wired connection, the monitoring unit 114 and the meeting manager unit 110 can be communicatively coupled to the communications network 116 through a wireless connection. As an example, the communications network 116 can be a wireless local area network (WLAN) or a wide area network (WAN), although any suitable type and number of networks are within the scope of the invention.

In one arrangement, a meeting may be scheduled for a room 120, such as the one containing the monitoring unit 114 in FIG. 1. The monitoring unit 114 can detect one or more mobile communications devices 122(A-E) that belong to meeting participants as these participants enter the room 120 (the mobile communications devices 122(A-E) may also be referred to simply as mobile devices 122 or devices 122). As such, the monitoring unit 114 can be any suitable wired or wireless sensor that can detect the mobile devices 122 and can forward this detection to the meeting manager unit 110. For example, the monitoring unit 114 can be a node that is part of a sensor network, such as a neuRFon™ network that is produced by Motorola, Inc. of Schaumburg, Ill.

In another arrangement, the mobile communications devices 122(A-E) can be considered monitoring units. In particular, the component 114 previously referred to as a monitoring unit 114 can be a location beacon 114 that periodically broadcasts an identifier that identifies the particular location in which the location beacon 114 is positioned. In this case, the mobile communications devices 122 can receive the identifier from the location beacon 114 and can forward this detection to the meeting manager unit 110 through the communications network 116.

In either arrangement described above, efforts can be made to limit the range of the monitoring unit 114 or the location beacon 114 to an area that roughly corresponds to the size of the room in which they are positioned. This principle can help reduce the chances that a scheduled meeting participant will be falsely detected in the meeting location should that person be present in an adjacent room or in a nearby hallway.

It is understood, however, that the invention is not limited to this particular configuration. For example, all or some of the meeting manager unit 110, the event database 112 and the communications network 116 may be contained within the building 118 or even a particular room 120 of the building 118. Moreover, the meeting location is not limited to being in a room of a building, as a meeting location can be defined as any suitable place where any suitable meeting can be held. Also, the term meeting is not necessarily limited to a group of individuals who are physically located in the same general area. For example, the meeting may include individuals who are attending the meeting through a conference call or video call.

To account for this scenario, the monitoring unit 114 can be equipped with one or more components for detecting a connection between communications equipment located at the meeting location and any meeting participants who are remotely attending. This configuration may also apply when the mobile communications device(s) 122 serve as the monitoring unit 114. That is, either the location beacon 114 or the devices 122 can detect the connection of the remote participants and can forward this information to the meeting manager unit 110.

The system 100 may also include a tracking network 124, which can be used to track the location of scheduled meeting participants. For example, one or more nodes (not shown) may be positioned throughout the building 118, each of which is able to detect the mobile communications devices 122(A-E). The tracking network 124 may then forward this tracking location information to the meeting manager unit 110 through the communications network 116 or some other suitable network. The nodes of the tracking network 124 may be similar to the monitoring unit 114 described above, although the tracking network 124 can use any suitable components or technology to track the mobile communications devices 122(A-E).

It is understood, however, that the tracking network 124 is not limited to being positioned within the building 118. In particular, the mobile communications devices 122(A-E)—through GPS technology—can forward their locations to the meeting manager unit 110. Additionally, one or more base stations (not shown) that are in communications with the mobile communications devices 122(A-E) may forward such information to the meeting manager unit 110, which can provide the unit 110 with an estimate as to the position of the devices 122(A-E). Those of skill in the art will appreciate that there are numerous ways to track mobile communications devices 122 and to provide this tracking information to the meeting manager unit 110. Several other methods are presented in U.S. patent application Ser. No. 11/022,095, which is incorporated herein by reference.

In one particular arrangement, the mobile communications devices 122(A-E) are equipped to participate in dispatch or simplex communications. The network handling this type of communications may or may not be part of the communications network 116. As is known in the art, any one of the mobile communications devices 122(A-E) can be configured to contact a plurality of other dispatch devices through a group calling process. In this process, a dispatch user can press a push-to-talk button and can communicate simultaneously with a plurality of other dispatch users.

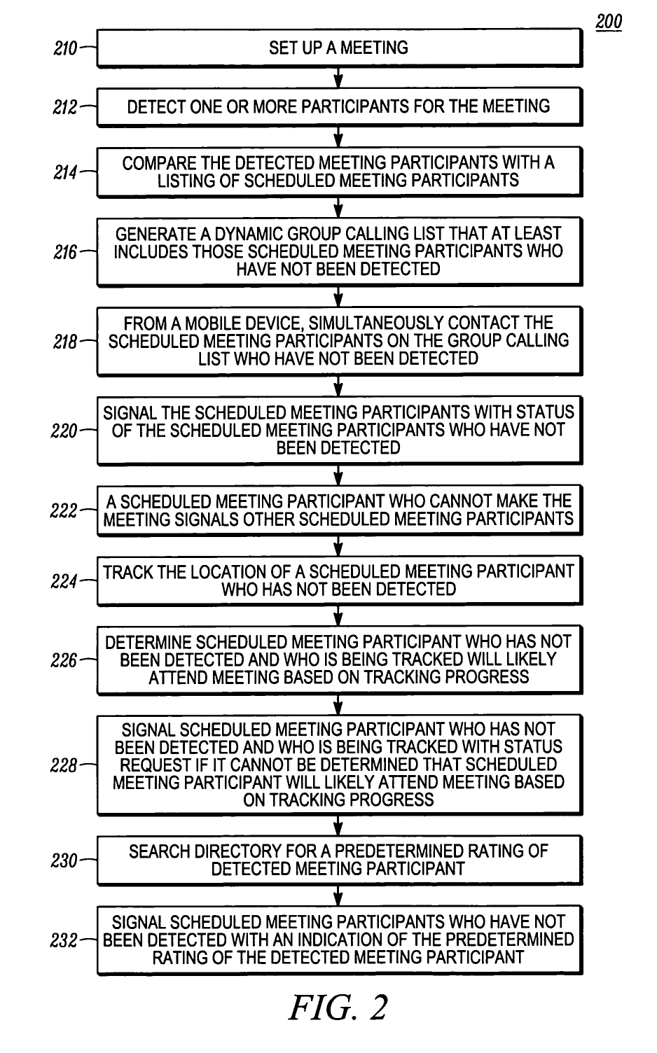

Referring to FIG. 2, a method 200 for managing meetings is shown. When describing the method 200, reference will be primarily made to FIG. 1, although it is understood that the method 200 can be practiced in any other suitable system or device. Moreover, the steps of the method 200 are not limited to the particular order in which they are presented in FIG. 2. The inventive method can also have a greater number of steps or a fewer number of steps than those shown in FIG. 2.

At step 210, a meeting can be set up, and at step 212, one or more participants for the meeting can be detected. The detected meeting participants can be compared with a listing of scheduled meeting participants, as shown at step 214. In addition, at step 216, a dynamic group calling list that at least includes those scheduled meeting participants who have not been detected can be generated. As an example, at step 218, the scheduled meeting participants on the group calling list who have not been detected can be simultaneously contacted from a mobile device.

For example, referring to FIG. 1, a user can set up a meeting through any suitable system, such as any number of calendar programs that provide this service. The meeting can be arranged through a computing network or through one or more of the mobile communications devices 122(A-E). Individuals who are assigned to this meeting can be designated with any suitable reference that identifies them, and this listing can be forwarded to and stored at the events database 112.

At an appropriate time, one or more of the participants of the meeting can be detected. The term detecting can include any suitable process for determining that a meting participant is at the meeting location or is otherwise ready to participate in the meeting. For example, at a predetermined time—such as thirty minutes before the start of the meeting—the monitoring unit 114 can begin to detect the mobile communications devices 122(A-E) of the scheduled meeting participants. When detected, the monitoring unit 114 can forward this event to the meeting manager unit 110. In another arrangement, if the mobile communications devices 122(A-E) serve as the monitoring unit, the devices 122(A-E) can detect the location beacon 114 as the devices enter the meeting room 120 and in response, can signal the meeting manager unit 110. Scheduled meeting participants can also be detected and the meeting manager unit 110 can be notified, as explained previously.

The meeting manager unit 110 can collect the identities of the detected meeting participants and can then compare the detected meeting participants with the listing stored in the event database 112. Based on this comparison, the meeting manager unit 110 can determine which of the scheduled meeting participants have not been detected and can generate a dynamic group calling list that at least includes these individuals. The meeting manager unit 110 can forward the group calling list to, for example, one or more of the mobile communications devices 122(A-E), such that the group calling list can be generated on one or more of the devices 122. As a more specific example, the meeting manager unit 110 can forward the group calling list to one of the devices 122 that are currently at the meeting location, such as device 122A, 122B and/or 122C. This process can also include the devices 122 of individuals who are participating in the meeting remotely.

As is known in the art, a group calling list allows a user of a dispatch communications device to simultaneously contact the dispatch communications devices of individuals in the list. As such, in this example, the mobile devices 122A, 122B and/or 122C could simultaneously contact scheduled meeting participants who have not yet been detected, such as devices 122D and 122E. Such a process can enable meeting participants who have been detected to determine the status of those scheduled participants who have not been detected.

For purposes of the invention, the term “dynamic group calling list” can be any list of contact information that can be updated and that can enable a user of a communication device to at least substantially simultaneously contact other communication devices used by individuals identified by the list. While the description here has focused on a dispatch device contacting other dispatch devices, it must be understood that the invention is not so limited. In particular, devices like a personal digital assistant, a wireless e-mail unit, a desktop computer or any other suitable electronic device that can participate in a group communication is within the scope of the invention.

Although FIG. 1 shows the meeting manager unit 110 and the event database 112 as being separate entities from the mobile devices 122(A-E), the invention is not so limited. For example, the meeting manager unit 110 and the event database 112 can actually be part of one or more of the mobile communications devices 122(A-E). Specifically, one of the devices 122 can handle the duties of the meeting manager unit 110, can access information from an internal database (i.e., event database) and can share information with other devices 122 over the communications network 116.

Referring back to FIG. 2, at step 220, the scheduled meeting participants can be signaled with the status of the scheduled meeting participants who have not been detected. For example, at step 222, a scheduled meeting participant who cannot make the meeting can signal other scheduled meeting participants about his/her inability to attend the meeting. As another example, as step 224, the location of a scheduled meeting participant who has not been detected can be tracked. In addition, it can be determined whether the scheduled meeting participant who has not been detected and who is being tracked is likely to attend the meeting based on this tracking process, as shown at step 226. Further, at step 228, the scheduled meeting participant who has not been detected and who is being tracked can be signaled with a status request if it cannot be determined that the scheduled meeting participant will likely attend the meeting based on the tracking process.

For example, referring back to FIG. 1, the mobile devices 122 of the scheduled meeting participants can be signaled with an indication as to the status of one or more of the scheduled meeting participants who have not been detected by the monitoring unit 114. In particular, a scheduled participant who cannot make the meeting can signal the meeting manager unit 110 (or one of the other devices 122) with a notice that he/she will not be able to attend. The meeting manager unit 110 can then signal the mobile devices 122 of the other scheduled participants of this status.

As another example, the tracking network 124 can track the location of the mobile devices 122 of those scheduled participants who have not been detected. As noted earlier, the tracking network 124 can be any suitable system for monitoring the location of the mobile devices 122(A-E) and is not limited to tracking the devices 122 only while the devices 122 are located in the building 118. The tracking network 124 can forward the tracking information to the meeting manager unit 110. In response, the meeting manager unit 110—using any suitable, well-known algorithm—can determine the likelihood that one or more of the scheduled meeting participants who have not been detected will attend the meeting.

For example, the tracking network 124 can forward to the meeting manager unit 110 tracking information concerning the mobile device 122D, which can provide an indication that the mobile device 122D is nearing the meeting room 120. In response, the meeting manager unit 110 can determine that the mobile device 122D will likely attend the meeting based on its proximity near the meeting room 120 and its previous and current movement. The meeting manager unit 110 can then signal the other scheduled meeting participants—through any suitable notification process—that the meeting participant carrying the mobile device 122D will likely attend the meeting.

As another example, the tracking network 124 can provide the location of the mobile device 122E, which may be stationary. The meeting manager unit 110 may determine that the scheduled participant who is carrying mobile device 122E may not likely or will not likely attend the meeting based on the lack of movement exhibited by the mobile device 122E. In addition, the meeting manager unit 110 can signal the other scheduled meeting participants of this determination. It is understood that this tracking and likelihood determination process may apply to mobile devices 122 that are either inside or outside the building 118.

In another arrangement, if it determines that a particular scheduled meeting participant may not attend the meeting, the meeting manager unit 110 may signal that participant's mobile device 122, such as mobile device 122E. The meeting participant may wish to respond to the meeting manager unit 110 by confirming whether he/she will participate in the meeting, and the meeting unit 110 can forward this information to the other scheduled meeting participants.

Referring back to FIG. 2, at step 230, a directory can be searched for a predetermined rating of a detected meeting participant. At step 232, scheduled meeting participants who have not been detected can be signaled with an indication of the predetermined rating of the detected meeting participant.

For example, referring once again to FIG. 1, the event database 112 can be loaded with a directory that includes predetermined ratings of a certain number of individuals. As an example, a rating can be an employee classification that provides an indication as to the significance of the detected meeting participant to the meeting. Specifically, when a scheduled meeting participant is detected, the meeting manager unit 110 searches the event database 112 for the predetermined rating of this person. Once obtained, the meeting manager unit 110 can broadcast this information to the scheduled meeting participants who have not been detected. As such, these participants can determine when, for example, a meeting moderator or a high-ranking company official has been detected at the meeting location. Of course, the invention is not limited to the rating being an employee classification, as the rating can be any other suitable designation.

In one arrangement, the meeting manager unit 110 can be set to only notify the scheduled meeting participants who have not been detected of the predetermined rating of a detected meeting participant if that rating is above a predetermined threshold. This way, these participants may be notified of only those detected meeting participants whose participation in the meeting is relatively important.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for managing meetings using group calling, comprising:
detecting one or more meeting participants for a meeting;
comparing the detected meeting participants with a listing of scheduled meeting participants; and
generating a dynamic group calling list that at least includes those scheduled meeting participants who have not been detected.

2. The method according to claim 1, wherein generating the dynamic group calling list further comprises generating the dynamic group calling list on a mobile communications device of one of the detected meeting participants.

3. The method according to claim 2, further comprising simultaneously contacting from the mobile communications device the scheduled meeting participants on the dynamic group calling list who have not been detected.

4. The method according to claim 1, further comprising signaling the scheduled meeting participants with an indication of the status of each of the scheduled meeting participants who have not been detected.

5. The method according to claim 1, further comprising:
searching a directory for a predetermined rating of a detected meeting participant; and
signaling the scheduled meeting participants who have not been detected with an indication of the predetermined rating of the detected meeting participant.

6. The method according to claim 5, wherein the predetermined rating is an employee classification that provides an indication as to the significance of the detected meeting participant to the meeting.

7. The method according to claim 1, wherein a scheduled meeting participant who cannot make the meeting signals the other scheduled meeting participants that he/she cannot attend the meeting.

8. The method according to claim 1, further comprising:
tracking the location of a scheduled meeting participant who has not been detected;
determining that the scheduled meeting participant who has not been detected and who is being tracked will likely attend the meeting based on the tracking process; and
signaling the other scheduled meeting participants with an indication that reflects this determination.

9. The method according to claim 8, further comprising signaling the scheduled meeting participant who has not been detected and who is being tracked with a status request if it cannot be determined that the scheduled meeting participant will likely attend the meeting based on the tracking process.

10. The method according to claim 1, wherein the detected meeting participants are either physically detected at a meeting location or are in communications contact with the detected meeting participants physically detected at the meeting location.

11. A method for managing meetings, comprising:
detecting one or more meeting participants for a meeting;
comparing the detected meeting participants with a listing of scheduled meeting participants; and
signaling mobile communications devices of scheduled meeting participants who have not been detected with an indication of a predetermined rating of at least one of the detected meeting participants, wherein the predetermined rating is an employee classification that provides an indication as to the significance of the detected meeting participant to the meeting.

12. A system for managing meetings, comprising:
a monitoring unit that detects one or more participants for a meeting;
an event database that stores information concerning the meeting, including at least a list of scheduled meeting participants; and
a meeting manager unit communicatively coupled to the monitoring unit and the event database, wherein the monitoring unit signals the meeting manager unit when it detects a meeting participant and the meeting manager unit compares the detected meeting participants with the list of scheduled meeting participants and generates a dynamic group calling list that at least includes those scheduled meeting participants who have not been detected.

13. The system according to claim 12, wherein the meeting manager unit signals a mobile communications device of one of the detected meeting participants with the generated dynamic group calling list.

14. The system according to claim 13, wherein the signaled mobile communications device has the capability of simultaneously contacting the scheduled meeting participants on the dynamic group calling list who have not been detected.

15. The system according to claim 12, wherein the meeting manager unit signals the scheduled meeting participants with an indication of the status of each of the scheduled meeting participants who have not been detected.

16. The system according to claim 12, wherein the event database also includes a directory that has a predetermined rating of a detected meeting participant and wherein the meeting manager unit searches the directory and signals the scheduled meeting participants who have not been detected with an indication of the predetermined rating of the detected meeting participant.

17. The system according to claim 16, wherein the predetermined rating is an employee classification that provides an indication as to the significance of the detected meeting participant to the meeting.

18. The system according to claim 12, wherein a scheduled meeting participant who cannot make the meeting signals the other scheduled meeting participants that he/she cannot attend the meeting.

19. The system according to claim 12, further comprising a tracking network that tracks the location of a scheduled meeting participant who has not been detected and signals the meeting manager unit with this tracking location information, wherein the meeting manager unit determines that the scheduled meeting participant who has not been detected and who is being tracked will likely attend the meeting based on the tracking process and signals the other scheduled meeting participants with an indication that reflects this determination.

20. The system according to claim 12, wherein the monitoring unit detects meeting participants who are either physically at a meeting location or are in communications contact with the detected meeting participants physically at the meeting location.

21. The system according to claim 20, wherein the monitoring unit is a node permanently positioned inside a location for the meeting or is a mobile communications device that receives a signal from a location beacon positioned inside the location for the meeting.
